(19) United States
(12) Patent Application Publication
(10) Pub. No.: US 2006/0287620 A1
(43) Pub. Date: Dec. 21, 2006

(54) Power massager

(76) Inventor: Jung-Chun Tseng, Taoyuan City (TW)

Correspondence Address: TROXELL LAW OFFICE PLLC, SUITE 1404, 5205 LEESBURG PIKE, FALLS CHURCH, VA, 22041, US

(21) Appl. No.: 11/154,830

(22) Filed: Jun. 17, 2005

(51) Int. Cl. A61H 7/00

(52) U.S. Cl. 601/94; 601/101; 601/134

(57) ABSTRACT

A power massager to respectively work on the neck and shoulders of its user includes a drive unit to drive two press plates to oscillate for massaging the neck; two finger press units coupled to a transmission shaft on the outer sides of both press plate; each finger press unit being separately provided a hammer; and the hammer as driven by the transmission shaft continuously operates to massage the shoulders.

### BACKGROUND OF THE INVENTION

(a) Field of the Invention

The present invention is related to a power massager, and more particularly, to one that provides finger pressing and kneading effects respectively on one's neck and shoulders.

(b) Description of the Prior Art

For reasons of being subject to excessive stress of longer hours of working or studying, people today are vulnerable to stiff and sour neck and/or shoulders. Therapy to cure sour shoulders varies depending on the particular cause. Among the therapies available, proper massage may be so far the most direct and effective method to mitigate the stiff and sour neck and/or shoulders. After the proper massage, symptom including poor contraction of blood vessels and circulation as well as the involuntary contraction and stiffness of the muscles is significantly improved while the accumulation of those substances blamed for physical pains are eliminated by metabolized to avoid the malicious cycling of physical pains.

The idea of relaxing one's bones and muscles to get rid of fatigue is originated from Chinese medicine that promotes the massage by guiding and pressing on the affected part of the human body. By applying the manual skills of pressing and touching, or by means of general exercise of the joints and muscles, the circulation at the local part and even the general mechanism of a human body can be improved. As the distribution of one's critical points of nerve system and muscles vary on one's body, the technique and method of massage also differ.

Most of the power massagers available in the market operate by mechanism transmission to simulate the kneading action by fingers (or palms) to massage one's neck.

However, only by proper finger pressing to relax the muscles of the shoulders, the sour shoulders can be relieved. Therefore, the prior art that works only on the neck is not able to satisfy the purpose of massaging the neck and the shoulders at the same time.

### SUMMARY OF THE INVENTION

The primary purpose of the present invention is to provide a power massager that works on one's neck and shoulders at the same time. To achieve the purpose, two press plates oscillate are adapted to knead one's neck on both sides. Furthermore, at both ends of a transmission shaft to drive both press plates are respectively coupled with a finger press unit and each finger press unit is disposed with one or a plurality of hammer driven by the transmission shaft to simulate the finger press motion. Both of the pair of the pressing plates and the pair of the finger press units operate synchronously to produce kneading and finger pressing effects on the neck and shoulders of the user.

### BRIEF DESCRIPTION OF THE DRAWINGS

FIG. 1 is a perspective view of the present invention.

FIG. 2 is an exploded view of the present invention.

FIG. 3 is a sectional view showing the construction of a drive unit in the present invention.

FIG. 4 is a sectional view showing the construction of a pair of press plates in the present invention.

FIG. 5 is a perspective view of a finger press unit in the present invention.

FIG. 6 is a sectional view showing the construction of the finger press unit in the present invention.

FIG. 7 is a schematic view showing a status of the present invention is in use.

FIG. 8 is a perspective view showing another type of finger press unit in the present invention.

FIG. 9 is a perspective view of the present invention further adapted with a roller unit.

### DETAILED DESCRIPTION OF THE PREFERRED EMBODIMENTS

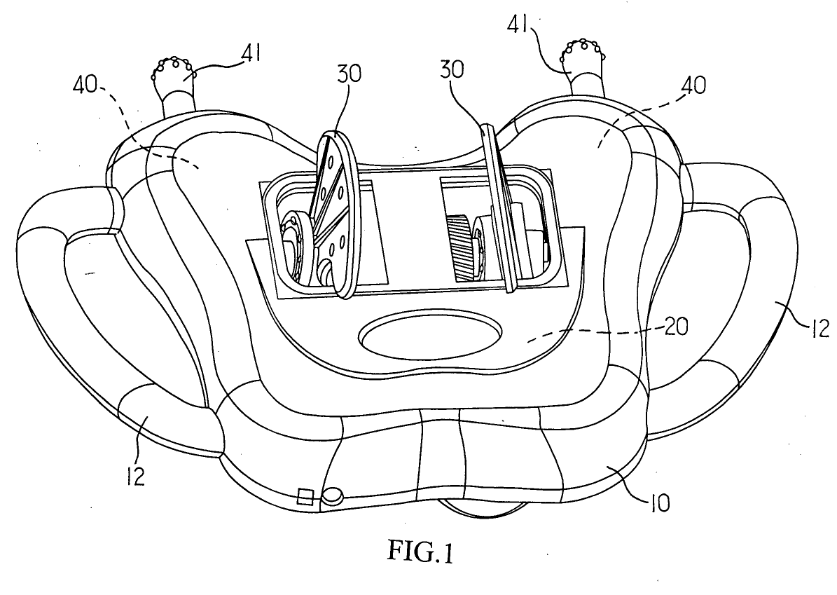

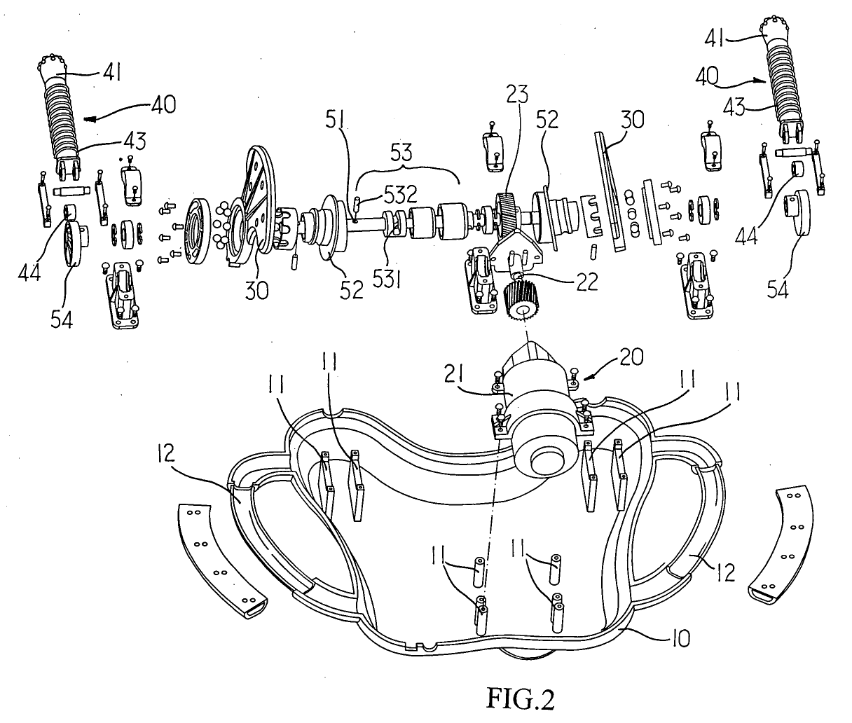

Referring to FIGS. 1 and 2, a preferred embodiment of the present invention is essentially comprised of a base 10, a drive unit 20, two press plates 30, two finger press units 40 and a transmission shaft 51. Wherein, the base 10 related to a primary mechanical structure for the assembly of all related members contains multiple retaining walls 11 to secure the members of the present invention and two handles on both sides to help the user to hold steady the massager of the present invention.

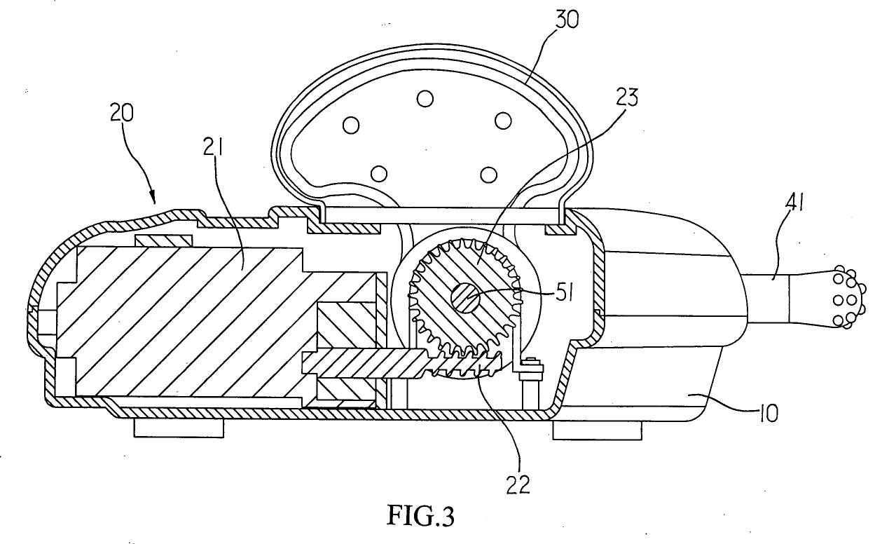

As illustrated in FIGS. 2 and 3, the drive unit 20 is comprised of a motor 21 to drive the transmission shaft to revolve. In practice, an active worm gear 2 is connected to the spindle of the motor 21 and a passive gear 23 engaged with the active worm gear 22 is connected to the transmission shaft. The motor 21 drives the transmission shaft 51 that is placed at a right angle to the spindle of the motor 21 to revolve through the transmission of the active worm gear 22 and the passive gear 23.

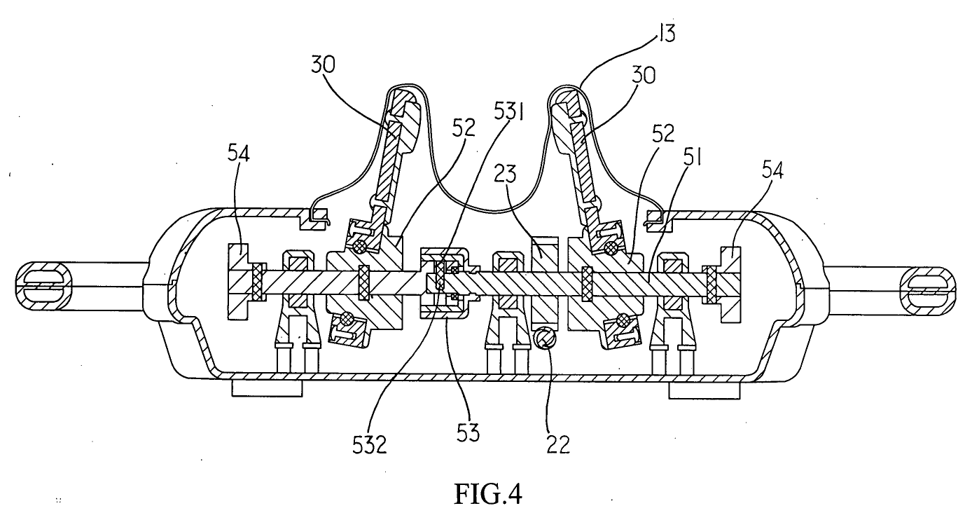

Each of both press plates 30 is coupled to the transmission shaft 51 by means of an oblique disk 52 as illustrated in FIGS. 2 and 4. Wherein, a reversing member 53 is disposed at where between one press plate 30 and the transmission shaft 51. A 180-degree insertion slot 531 is disposed to the reversing member 53. The transmission shaft 51 is coupled to the reversing member 53 by having a pin 532 inserted into the slot 531. Accordingly, when the reversing member 53 drives the transmission shaft to engage in reciprocal revolution for 180 degrees, both press plates 30 as driven by their respective oblique disks 52 reciprocally oscillate in cycle of clamping and releasing to massage the neck of a user by kneading or rubbing; or alternatively, both press plates 30 are positioned in parallel with each other by means of the reversing member 53 to manipulate the naprapathy.

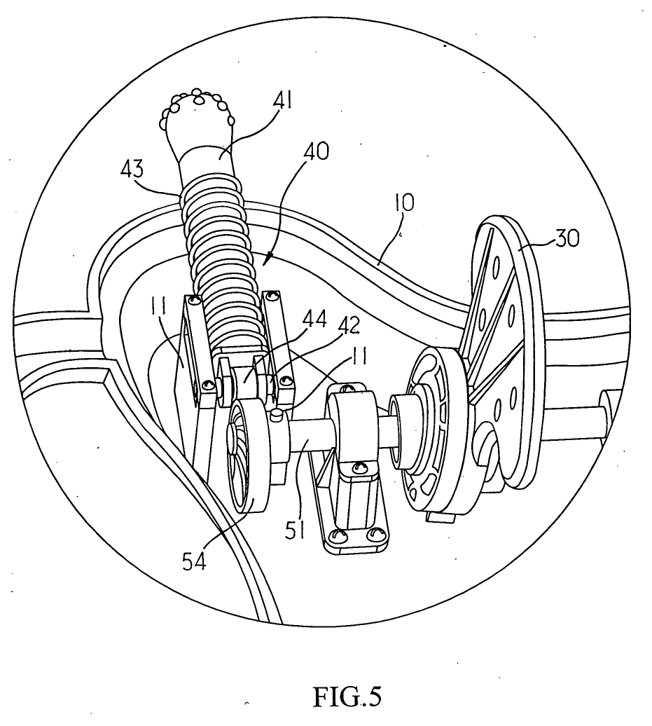

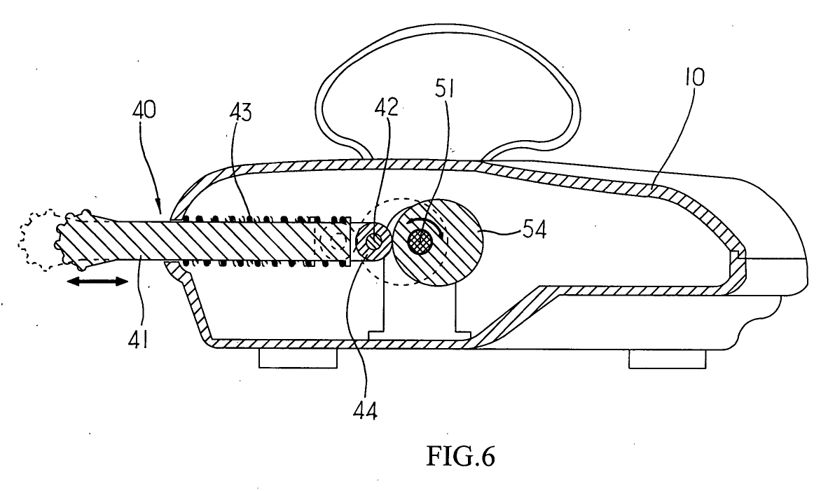

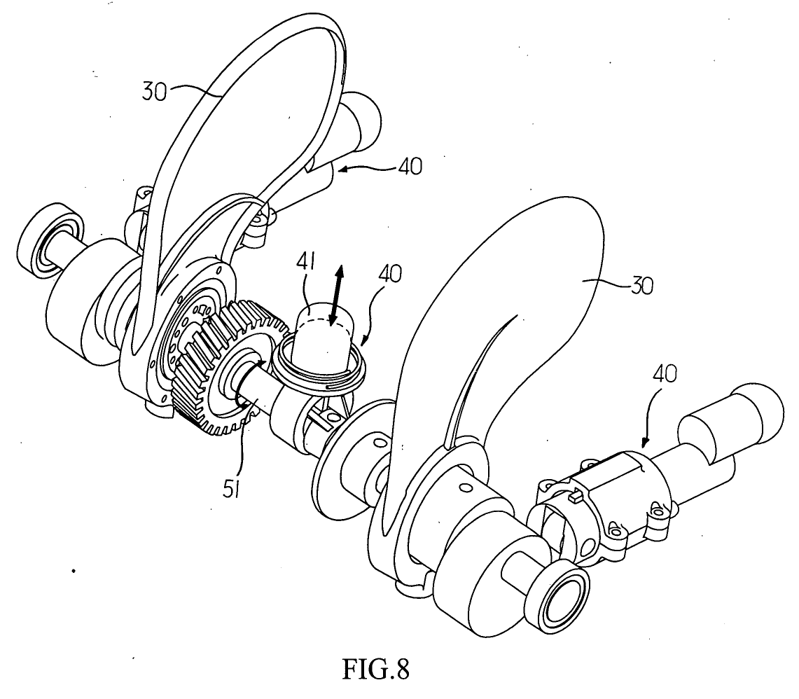

Both finger press units 40 are disposed at where externally to both press plates 30 as illustrated in FIGS. 5 and 6. Wherein, each finger press unit 40 is adapted with one or a plurality of hammer 41 to simulate continuous finger press motions as driven by the transmission shaft 51. In practice, each hammer is provided with a through shaft 42 at its root where penetrating into the base 10, and the through shaft 42 is secured in position by a pair of retaining walls 11 in the base 10. A coil 43 is inserted onto the hammer 41, and a cam 54 is each disposed at both ends of the transmission shaft 51. The hammer 41 and the cam 54 contact each other by means of the coil 43 in normal status. The through shaft 42 at the tail of the hammer 41 is inserted with a roller 44 to contact the cam 54. Accordingly, as the cam 54 revolves, it pushes against the hammer 41 to reciprocally expand and retract in the direction of following its axis. Furthermore, a third finger press unit 40 is disposed at the center of the transmission shaft as illustrated in FIG. 8. The third finger press unit 40 is also provided with one or a plurality of hammer 41 driven by the transmission shaft 51 to execute continuous motion of finger press.

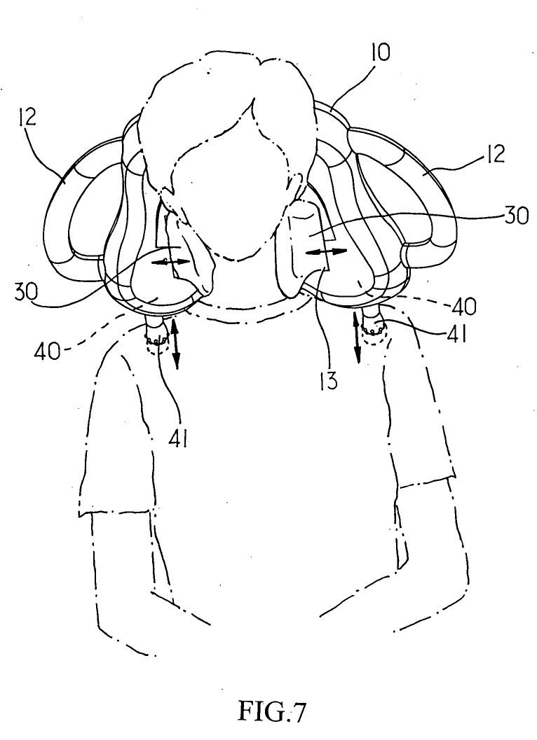

As driven by the same drive unit 20 as illustrated in FIG. 7, the power massager of the present invention has its both press plates 30 massage the neck of a user and both finger press units 40 synchronously massage shoulders of the user. Alternatively, the third finger press unit 40 executes naprapathy longitudinally on the spine of the user while the other two finger press units 40 work laterally on both shoulders of the user when driven by the same transmission shaft 51. As illustrated in FIGS. 4 and 7, a resilient cover 13 is further disposed to the base 10 to cover up both press plates 30 to improve use safety and comfort.

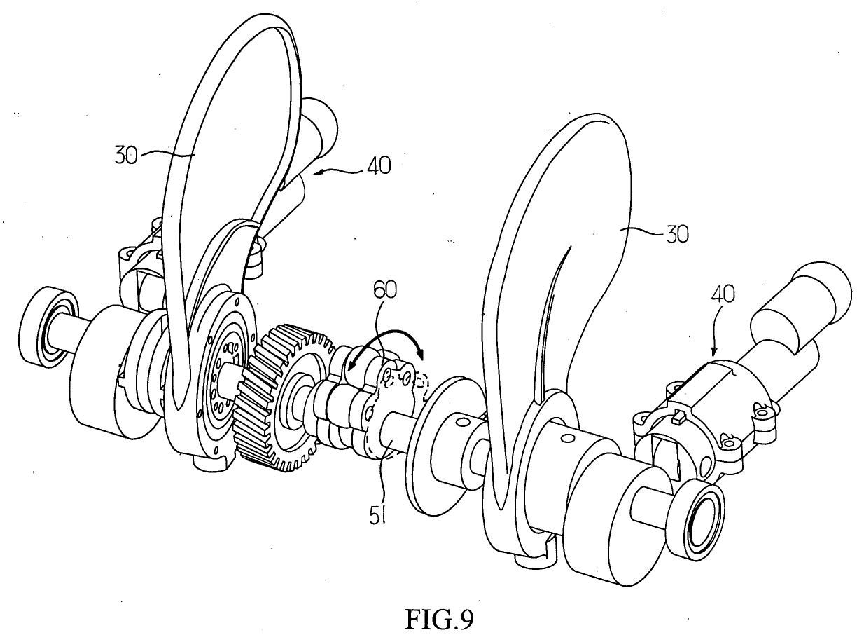

A rolling member 60 is further adapted to the transmission shaft 51 as illustrated in FIG. 9 in a structure similar to that of a cam. The rolling member 60 is located at where comparatively closer to the center of the transmission shaft 51 to massage the back of the user by rolling and pressing.

The prevent invention provides a power massager that produces massage effects by kneading and finger pressing separately on the neck and shoulders of the user at the same time, and the application for a patent is duly filed accordingly. However, it is to be noted that that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A power massager includes a base containing a drive unit; the drive unit comprised of a transmission shaft driven by a motor; two finger press units being coupled to the transmission shaft; each finger press unit being adapted with one or a plurality of hammer; the hammer as driven by the transmission shaft executing continuous motion of finger press.

2. A power massager includes a base containing a drive unit; two press plates being driven by the drive unit to execute the motion in cycle of clamping and releasing; both press plates being coupled to a transmission shaft; two finger press units being coupled to the transmission shaft; each finger press unit being adapted with one or a plurality of hammer; the hammer as driven by the transmission shaft executing continuous motion of finger press.

3. The power massager of claim 1, wherein multiple retaining walls are disposed at fixed locations inside the base to respectively secure essential members of the massager.

4. The power massager of claim 1, wherein two handles are provided to both sides of the base.

5. The power massager of claim 1, wherein the drive unit is comprised of a transmission shaft drive by a motor; an active worm gear is connected to the spindle of the motor; and a passive gear engaged with the active worm gear is connected to the transmission shaft.

6. The power massager of claim 1, wherein both press plates are respectively coupled to the transmission shaft through two oblique disks.

7. The power massager of claim 1, wherein both press plates are respectively coupled to the transmission shaft through two oblique disks; an revering member is disposed at where between the oblique disk of one press plate and the transmission shaft; a 180-degree insertion slot is disposed to the reversing member; and the transmission shaft is coupled to the reversing member by having a pin inserted into the slot.

8. The power massager of claim 1, wherein both finger press units are disposed to the outer sides of both press plates; a through shaft is adapted at one end of the hammer where penetrating into the base for each finger press unit; the through hole is secured by a pair of retaining walls in the base; a coil is inserted between the hammer and the retaining walls, a cam is each disposed at both ends of the transmission shaft; and the hammer and the cam constantly contact each other.

9. The power massager of claim 8, wherein a roller is inserted to the through shaft at the tail of the hammer to contact the cam.

10. The power massager of claim 1, wherein a resilient cover is disposed to the base to cover up both press plates.

11. A power massager includes a base containing a drive unit; the drive unit comprised of a transmission shaft driven by a motor; an active worm gear being connected to the spindle of the motor; and a passive gear engaged with the active worm gear being connected to the transmission shaft; both press plates being respectively coupled to the transmission shaft through two oblique disks; two press plates being driven by the drive unit to execute the motion in cycle of clamping and releasing; an revering member being disposed at where between the oblique disk of one press plate and the transmission shaft; a 180-degree insertion slot being disposed to the reversing member; the transmission shaft being coupled to the reversing member by having a pin inserted into the slot; two finger press units being coupled to the transmission shaft; each finger press unit being adapted with one or a plurality of hammer; the hammer as driven by the transmission shaft executing continuous motion of finger press; both finger press units being disposed to the outer sides of both press plates; a through shaft being adapted at one end of the hammer where penetrating into the base for each finger press unit; the through hole being secured by a pair of retaining walls in the base; a coil being inserted between the hammer and the retaining walls, a cam being each disposed at both ends of the transmission shaft; and the hammer and the cam constantly contacting each other.

12. The power massager of claim 11, wherein a roller member is provided to the transmission shaft at where closer to the center of the transmission shaft.

13. The power massager of claim 12, wherein the structure of the roller member is similar to that of a cam.

14. The power massager of claim 11, wherein a third finger press unit is disposed at the center of the transmission shaft.

15. The power massager of claim 14, wherein one or a plurality of hammer is disposed to the finger press unit, and the hammer being driven by the transmission shaft executes continuous motion of finger press.
